(19) United States
(12) Patent Application Publication
(10) Pub. No.: US 2025/0108536 A1
(43) Pub. Date: Apr. 3, 2025

(54) TEXTURED DRYWALL SURFACE REPAIR APPARATUS

(71) Applicant: PUNCHWORKERS, LLC, Dripping Springs, TX (US)

(72) Inventors: Matthew A. Beller, Dripping Springs, TX (US); Shannon E. Beller, Dripping Springs, TX (US)

(73) Assignee: PUNCHWORKERS, LLC, Dripping Springs, TX (US)

(21) Appl. No.: 18/899,001

(22) Filed: Sep. 27, 2024

Related U.S. Application Data
(60) Provisional application No. 63/647,470, filed on May 14, 2024.
(60) Provisional application No. 63/557,144, filed on Feb. 23, 2024.
(60) Provisional application No. 63/586,937, filed on Sep. 29, 2023.

(51) Int. Cl. B28B 19/00; B28B 17/00

(52) U.S. Cl. CPC B28B 19/00; B28B 17/0036

(57) ABSTRACT

Apparatus and associated methods relate to textured drywall surface repair apparatus (TDSRA). The textured drywall surface repair apparatus (TDSRA) includes a centering protrusion member extending along a longitudinal axis. The TDSRA includes a surface removing member proximally disposed to a distal end of the centering protrusion member configured to create a cavity with a predetermined cross-sectional area when rotated about the longitudinal axis. The TDSRA includes a surface interface plane member disposed proximally to a distal end of the surface removing member and at least partially radially outward from the surface removing member such that the cavity is limited to a predetermined depth. In some embodiments, the predetermined depth is less than a thickness of the material in which the cavity is made. The patch may, for example, have a textured surface and a thickness equal to the predetermined depth and corresponding to the predetermined cross-sectional area.

### CROSS-REFERENCE TO RELATED APPLICATIONS

This application claims the benefit of U.S. Application Ser. No. 63/586,937, titled “Textured Drywall Surface Repair Apparatus,” filed by Mathew Beller, et al. on Sep. 29, 2023.

This application also claims the benefit of U.S. Provisional Application Ser. No. 63/557,144, titled “Textured Drywall Repair Apparatus,” filed by Mathew Beller, et al. on Feb. 23, 2024.

This application also claims the benefit of U.S. Provisional Application Ser. No. 63/647,470, titled “Textured Drywall Repair Apparatus,” filed by Mathew Beller, et al. on May 14, 2024.

This application incorporates the entire contents of the foregoing applications herein by reference.

### TECHNICAL FIELD

Various embodiments relate generally to repair tools and apparatuses.

### BACKGROUND

Modern architecture has developed from historical techniques of construction and material selection. Architects have traditionally selected from among widely available materials for constructing buildings that include commercial or residential purposes.

The construction materials can include exterior facing surfaces, such as exterior walls and roofing surfaces. Construction materials used on such exterior surfaces may include, for example, brick, concrete, wood, glass and metal. Inside the exterior surfaces, interior construction materials can be used that may have different design parameters than the construction materials used on the exterior surfaces.

Interior surfaces may typically be protected from weather elements, such as rain, wind, and sun, by virtue of the protection afforded by the exterior facing surfaces. Accordingly, architects may select construction materials for interior applications that have different structural properties.

Drywall is a construction material that may be used as a construction material for interior surfaces. Drywall has properties that make it susceptible to impact damage. In some cases, impact damage to a drywall surface can lead to, for example, punctures or other irregular deformations of a planar drywall surface.

### SUMMARY

Apparatus and associated methods relate to textured drywall surface repair apparatus (TDSRA). The textured drywall surface repair apparatus (TDSRA) includes a centering protrusion member extending along a longitudinal axis. The TDSRA includes a surface removing member proximally disposed to a distal end of the centering protrusion member configured to create a cavity with a predetermined cross-sectional area when rotated about the longitudinal axis. The TDSRA includes a surface interface plane member disposed proximally to a distal end of the surface removing member and at least partially radially outward from the surface removing member such that the cavity is limited to a predetermined depth. In some embodiments, the predetermined depth is less than a thickness of the material in which the cavity is made. The patch may, for example, have a textured surface and a thickness equal to the predetermined depth and corresponding to the predetermined cross-sectional area.

Various embodiments may achieve one or more advantages. The TDSRA may, for example, allow for precise removal of existing wall texture, creating uniform cavities that accommodate pre-textured patches, ensuring seamless repairs. The TDSRA may, for example, accommodates various wall textures like smooth, orange peel, or knockdown, making it suitable for different types of textured drywall surfaces. The TDSRA may, for example, allow for quick and efficient repairs, reducing the time may to restore damaged drywall. The TDSRA may, for example, allow a user to guiding the user to center and shape the cavity, making the tool user-friendly even for non-professionals. The TDSRA may, for example, allow a user to minimize waste material by reducing the amount of drywall material removed, minimizing waste and ensuring a neat repair process without excess debris. The TDSRA may, for example, be used to create a flush fit between the wall patch and the existing texture of the drywall.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary textured drywall surface repair apparatus (TDSRA) employed in an illustrative use-case scenario.

FIG. 2A depicts an exemplary TDSRA embodiment schematic

FIG. 2B depicts an exemplary TDSRA assembly.

FIG. 3 depicts an exemplary TDSRA method.

FIG. 4A depicts a front perspective view of an exemplary TDSRA embodiment.

FIG. 4B depicts a back perspective view of an exemplary TDSRA embodiment.

FIG. 5A depicts a perspective view of an exemplary TDSRA embodiment.

FIG. 5B depicts a perspective view of an exemplary TDSRA embodiment.

FIG. 6A depicts a perspective view of an exemplary TDSRA embodiment assembly.

FIG. 6B depicts a perspective view of an exemplary TDSRA embodiment handle with different TDSRA attachments.

FIG. 7 depicts an exemplary assembly of an exemplary TDSRA embodiment.

FIG. 8 depicts an exemplary disassembly of an exemplary TDSRA embodiment.

FIG. 9 depicts an exemplary putty pack assembly.

FIG. 10 depicts an exemplary series of wall patches.

FIG. 11 depicts an exemplary method of utilizing the TDSRA to repair damaged drywall.

FIG. 12 depicts an exemplary method of using a putty pack and TDSRA combination kit for wall repair.

FIG. 13 depicts an exemplary combination kit including a TDSRA and a set of putty packs.

Like reference symbols in the various drawings indicate like elements.

### DETAILED DESCRIPTION OF ILLUSTRATIVE EMBODIMENTS

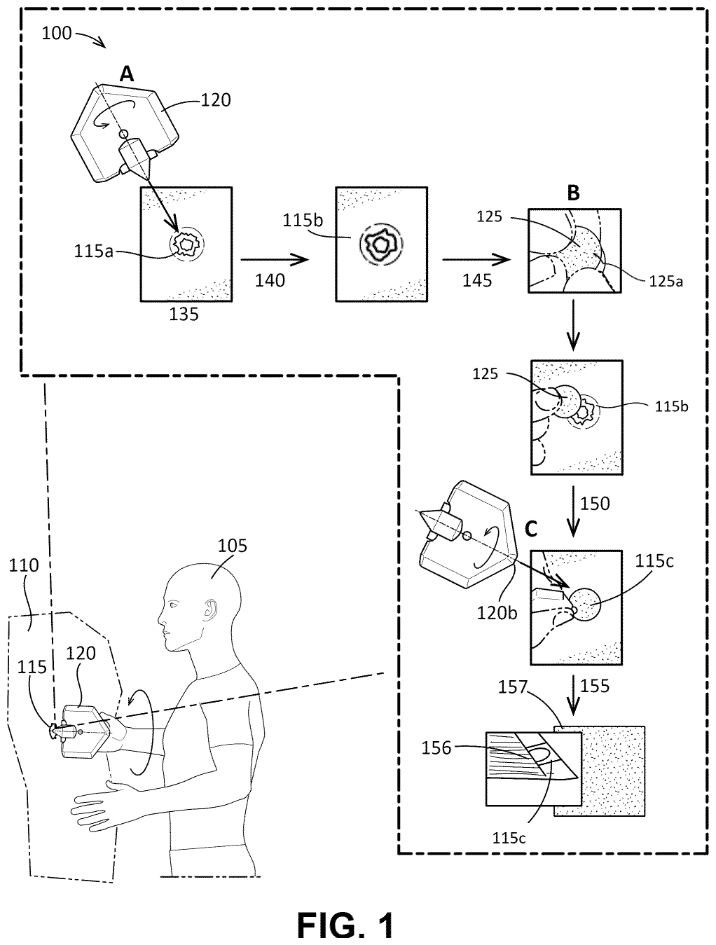

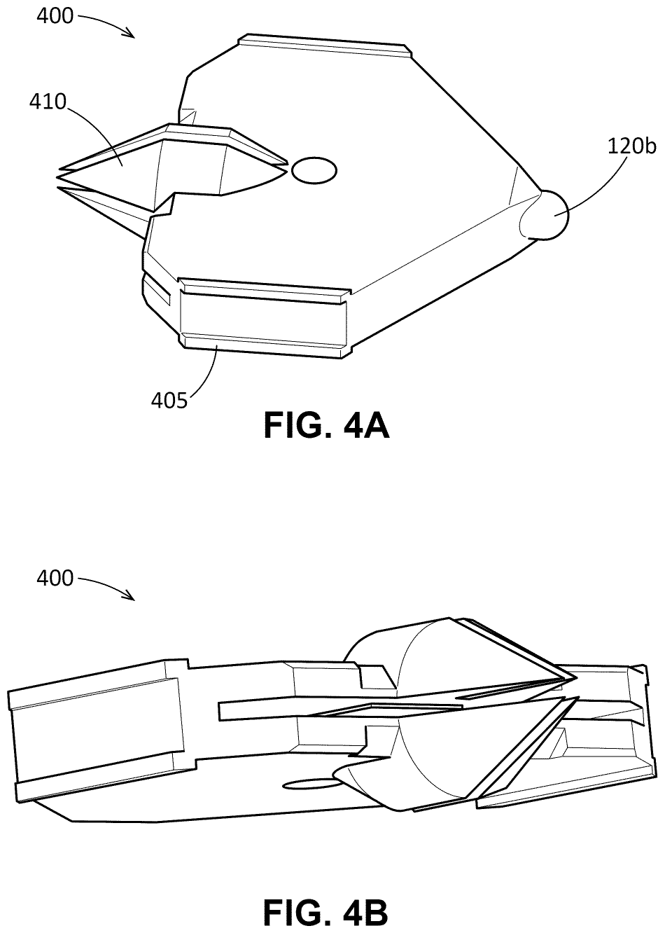

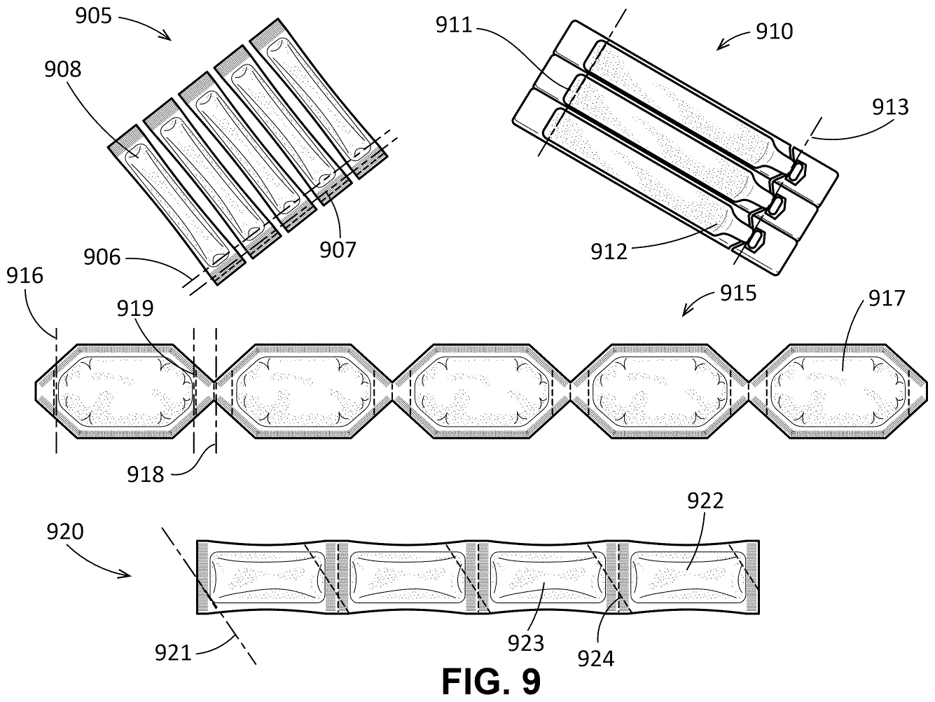

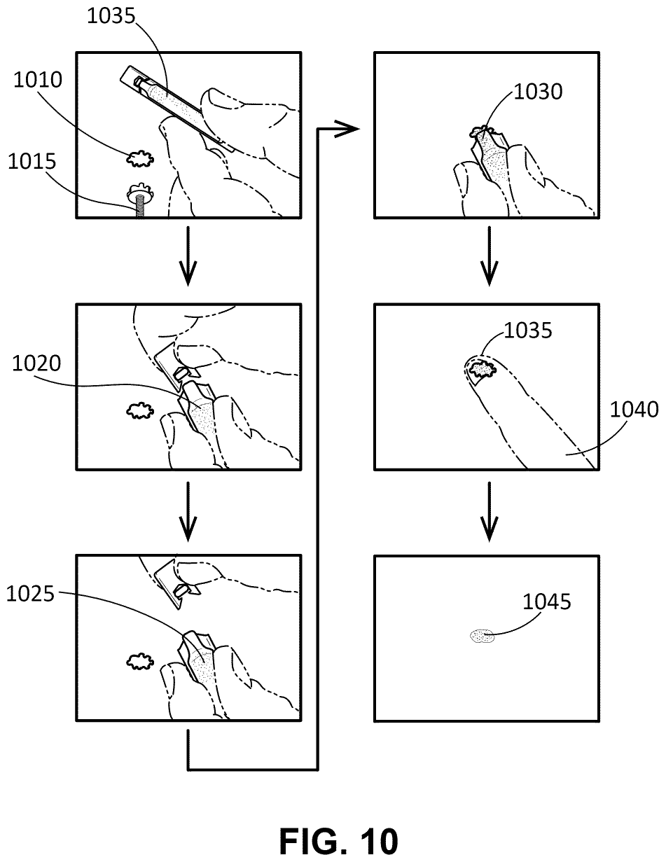

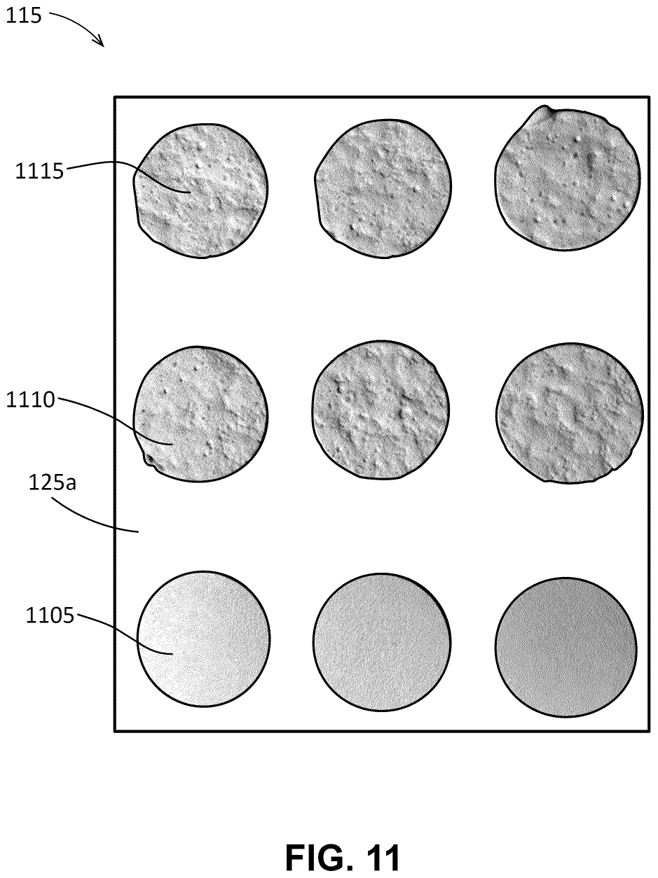

To aid understanding, this document is organized as follows. First, to help introduce discussion of various embodiments, a textured drywall surface repair apparatus (TDSRA) is introduced with reference to FIGS. 1-3B in an illustrative use-case scenario, schematic, and method. Second, that introduction leads to a description with reference to FIGS. 4A-8 of some exemplary embodiments of the TDSRAs. Third, with reference to FIG. 9-10, some exemplary putty pack and wall pack embodiments are discussed. Fourth, FIGS. 11-13 depict an exemplary method and exemplary kit is described in application to repair drywall using an exemplary TDSRA.

Apparatus and associated methods relate to textured drywall surface repair tool, kit, blade and/or method of applying a pre-textured wall patch. Repair surfaces may, for example, include drywall, plaster, or similar wall surfaces. The pre-textured wall patch may, for example, have a predetermined shape, size (e.g., diameter), and thickness. For example, the pre-textured wall patch may be circular. The texture repair tool may, for example, create a cavity by removing existing texture corresponding to the predetermined shape, size, and thickness of the selected pre-textured wall patch. The texture repair tool may, for example, include a centering projection. The centering projection may, for example, protrude from the center of the texture repair tool. The centering projection may be tapered (e.g., cone-shaped) such that the centering projection may, for example, register the tool into a hole (e.g., damage) in the wall surface. The tool includes a flange surrounding the centering projection. For example, the flange may limit the depth of insertion of the centering projection. The texture repair tool includes a blade protruding from the flange and extending beyond an outer diameter of the centering projection.

A distance of protrusion of the blade relative to the flange corresponds to a patch thickness. As the texture repair tool is inserted into the damage in the wall surface, and the texture repair tool is rotated, the centering projection centers the blade relative to the damage/hole in the wall, and the blade removes existing texture within a predetermined radius around the hole for a predetermined thickness of a patch. The width of the blade corresponds to the diameter of the pre-textured wall patch. Accordingly, the texture repair tool may advantageously remove existing texture on the wall surrounding the hole to create a cavity in the texture corresponding to the diameter and thickness of the pre-textured wall patch. The pre-textured wall patch is then inserted into the cavity such that the surface of the pre-textured wall patch is substantially flush with the existing wall texture surrounding the cavity. The pre-textured wall patch may, for example, be adhesive.

For example, the pre-textured wall patch may adhere to the wall inside the cavity. Accordingly, the pre-textured wall patch may advantageously provide a smooth replacement of wall texture over the damaged area in the wall. The tool may also include a blending projection. The blending projection may have a curved surface. For example, the blending projection may be domed (e.g., spherical). The tool may have a flat edge. The flat edge and/or the blending projection may be applied to a junction between the edge of the pre-textured wall patch and the existing texture. Applying the flat edge and/or the blending projection to the edges may, for example, break down sharp differences in the texture at the junction such that the edges blend smoothly together. In some embodiments, for example, the texture repair tool and the pre-textured wall patch may be advantageously operated to rapidly (e.g., in less than a minute) repair a damaged texture (e.g., in a textured drywall and/or sheetrock wall).

In some embodiments, the apparatus may, for example, include a blade embodiment. The blade cutting may, for example, be used to cut at the blade's midpoint. The blade may, for example, not cut all the way through the surface such that it cuts the surface into two pieces. The midpoint of the blade may, for example, include the midpoint of the blade. The cutting motion may, for example, make the tool rotate smoothly. The cutting motion may, for example, create a more geometrically uniform cavity. Other blade embodiments may, for example, be used.

In an illustrative example, apparatus and associated methods relate to a plaster container (putty container). The plaster container may, for example, include putty. The plaster container may, for example, be a sphere. The plaster container may, for example, be used for wall repair. The plaster container may, for example, be used to repair nail holes in the wall. The plaster container may, for example, be used to repair small holes in wall (e.g., nail holes). The plaster container may, for example, be small. The plaster container may, for example, include a thin layer of plastic. The plaster container may, for example, be stored in a jar. The plaster container may, for example, be stored on string. The plaster container may, for example, include twist off plaster. The plaster container may, for example, include a guiding valve for the plaster to exit out of the container.

FIG. 1 depicts an exemplary textured drywall surface repair apparatus (TDSRA) employed in an illustrative use-case scenario 100. The illustrative use-case scenario 100 includes a user 105. The user 105 is repairing a hole 110 in a section of drywall. The drywall includes a damaged portion of the drywall 115. The user is using an exemplary textured drywall surface repair apparatus (TDSRA) 120. The user 105 also has a repair patch 125. The user 105 pulled the TDSRA and repair patch from a preprepared kit. The user repairs the drywall with an exemplary method.

In step 135, a user determines the damaged wall portion's shape, size, wall thickness, and etc. The damaged drywall 115 includes an irregular shaped aperture 115a. The TDSRA 120 includes a centering protrusion 120a. The exemplary TDSRA 120 includes an exemplary surface removing member 170. The surface removing member may, for example, include a blade. The surface removing member may, for example, be proximally disposed to a distal end of the centering protrusion 120a member. The surface removing member 170 extends past a surface interface plane member 165. The surface interface plane member 165 may, for example, be disposed proximally to a distal end of the surface removing member 170.

In step 140, a user centers the TDSRA 120 onto the irregular shaped aperture 115a. The user may, for example, turn the TDSRA counterclockwise, counterclockwise, or alternating directions along the longitudinal axis of the device in motion A such that cone shape and blade create a predetermined shape cavity 115b. The surface removing member 170 may, for example, be configured to create a predetermined shape cavity 115b with a predetermined cross-sectional area when rotated about its longitudinal axis. The blade scrapes away the drywall texture as the TDSRA is turned around the cone. The regular shape may, for example, include a circle.

The cone and blade may, for example, create the properly sized cavity to accept the patch. The blade may, for example, carve the cavity. The texture of the drywall may, for example, be scraped off. Portions of the drywall may, for example, be removed to create the cavity.

In step 145, the user removes a patch 125 and is removed from a predetermined wall patch sheet 125a. (as depicted in motion B). The predetermined wall patch 125 is then applied to the damaged drywall with a predetermined shape cavity 115b. The predetermined patch may, for example, include a series of predetermined textures to match different types and textures of drywall.

In step 150, the user prepares and applies the drywall patch 125. to the damaged drywall. In step 150, the user applies a blender 120b of the TDSRA 120 is applied to the drywall. The blender 120b is used to blend the gap 115c between the patch and the damaged drywall.

In step 155, the user reinspects the wall. If the wall is blended the user has successfully repaired the wall. If the wall may more blending, the user will continue step 150 until the blending between the wall and patch is successful. The user may, for example, then apply plaster 158 to a brush 156 to paint the drywall surface 157 to cover the gap 115c.

In some embodiments, the TDSRA may, for example, allow for the repair of various sized anchor holes in walls. The TDSRA may, for example, include a centering pin component. The TDSRA may, for example, include a blade component. The TDSRA may, for example, include a body component. The body component may, for example, include a handle.

Some embodiments can change out the centering pin and/or blade if the blade and/or centering pin deteriorates. In some embodiments, may, for example, change out the centering pin and/or if different sizes are needed to carve out larger or smaller cavities in the textured wall surface for different sized textured patches.

In some embodiments, the TDSRA may, for example, seek to hold in blade into the tool's body cavity by inserting a centering pin component with a pronged base over (straddling) the blade that's set into the body cavity. The TDSRA may, for example, include a hole through the body component with a tapered end that narrows on the side opposite of the blade cavity. When the centering pin is pressed into the tapered through-hole within the body, the prongs begin to squeeze together. When this happens, the prongs squeeze to hold the base of the blade snug in the body and to the centering pin component. When this happens, the centering pin (e.g., centering protrusion) component holds tightly to the Body, maintaining the centering pin's conical tip steady relative to the blade, thus allowing for a better circular texture removal pattern to accommodate the circular textured patch. The pronged base of the centering pin component has half of the blending protrusions on each prong on the end opposite of the conical tip, and when the prongs are brought together as the centering pin component is pressed into the tapered through-hole, the blending protrusion halves come together to make a more hemispherical blending protrusion.

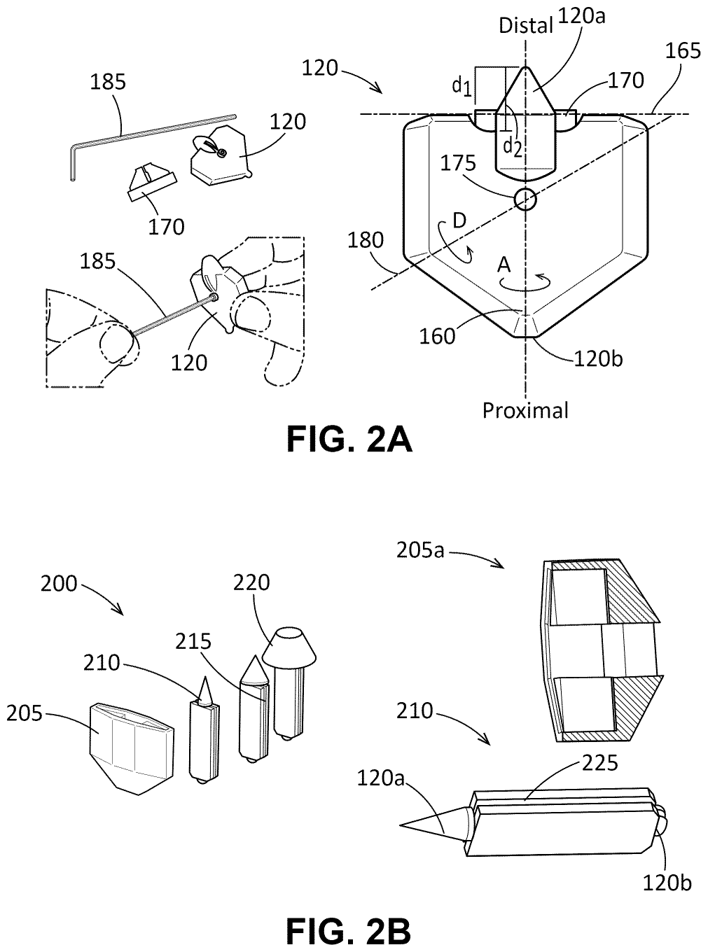

FIG. 2A-2B depicts views of an exemplary TDSRA embodiment 200. The exemplary TDSRA embodiment 200 includes a longitudinal axis 160. For example, the distal end of the TDSRA may be found near the tip of the TDSA. For example, the proximal end may be found as the rear of the TDSRA. The exemplary TDSRA embodiment includes a surface removing member 170. The surface removing device may, for example, include a blade. The body of the exemplary TDSRA includes an engagement aperture 175. The engagement aperture may, for example, receive a fastener a long engagement axis 180. A user may insert a fastener into the engagement aperture of the TDSRA and thread the fastener into the device coupling the blade to the device by revolving the fastener engagement tool in a motion d (twisting). The blade may, for example, be affixed to the TDSRA by use of a coupling device 185. The coupling device may, for example, include a L-bracket and a screw. A user may, for example, use the cone in conjunction with the blade of the TDSRA to create a predetermined aperture by turning the TDSRA.

The TDSR includes a centering pin. The centering pin may, for example, extend a predetermined distance d1 from the surface removing member, d1. The centering pin may, for example, extend a predetermined distance d2 from the surface interface plane d2. TDSR embodiments may, for example, have a d1 distance greater than the d2 distance. For example, as the TDSR is resolved along the longitudinal axis 160 in a motion A, the distance configuration of d2>d1 may, for example, allow the central protrusion to guide the path and center the surface removing mechanism as the TDSR rotates to remove the predetermined cross-area region corresponding to the surface removing mechanism. The depth of the protrusion may, for example, be constrained by d2. The surface interface plane member may, for example, be disposed proximally to a distal end of the surface removing member and at least partially radially outward from the surface removing member such that the cavity is limited to a predetermined depth. The centering protrusion may, for example, advantageously align the axis while the TDSR is cutting and rotated around the longitudinal axis to resist unalignment based on the reaction forces resisting the cutting of the surface removing member as the TDSR rotates.

In some embodiments, the TDSRA may, for example, include a centering pin insert that may, for example, be inserted into the centering pin. The centering pin insert may, for example, be used to couple the blade to the centering pin by use of friction created by a taper on the centering pin. The centering pin as inserted will begin to elastically deform creating a reaction force against the centering pin affixing the pin insert to the centering pin. The compressive forces of the pins of the pin insert may, for example, be used to hold the blade due to frictional forces.

FIG. 2B depicts an exemplary TDSRA assembly 200. The exemplary TDSRA assembly 200 includes a body 205. The exemplary TDSRA assembly 200 includes a narrow-tipped centering protrusion member 210. The exemplary TDSRA assembly 200 includes a rounded tipped centering protrusion member 215. The exemplary TDSRA assembly 200 includes a flat centering protrusion member 220. FIG. 2B depicts a cross-sectional view 205a of the TDSRA body 205. The narrow-tipped centering protrusion member 210 includes a tip 120a. The centering protrusion member 210 includes slides 225. The centering protrusion member 210 includes a blender 120b.

This embodiment may, for example, advantageously as the tool is rotated (counterclockwise, clockwise, or alternatively both directions) remove the texture on the wall surrounding the hole, the blade on each side of the centering projection will experience a force away from the direction of the tool's rotation as it removes the texture. The blade sections on each side of the centering projection will experience similar rotational force, which will cause one side of the blade to deflect in the opposite direction perpendicular to the blade as the opposite side of the blade.

For example, a solid blade may cause the blade to hop or “chatter” across the predetermined radius around the hole as the tool is rotated, creating an undesirable cavity shape to accept the pre-textured wall patch. For example, a solid blade may generate concentrated stresses along its midpoint during rotation and cause stresses that may lead to premature deterioration of the blade.

In the Appendix E embodiment, by cutting the blade in the center, it allows the single blade to deflect slightly on opposite ends, and thus rotate and move more smoothly along the surface of the texture on the wall surrounding the hole.

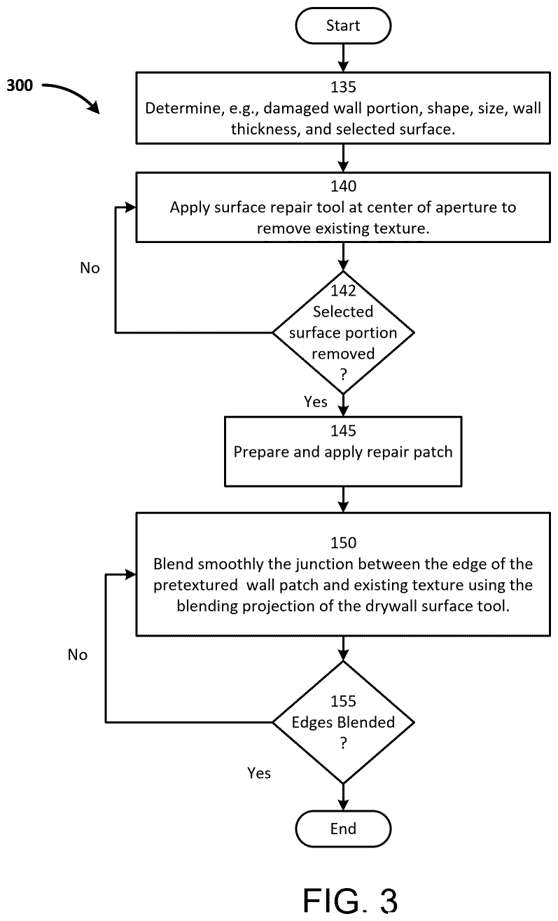

FIG. 3 depicts an exemplary TDSRA method 300 of utilizing the TDSRA to repair damaged drywall. In step 135 a user determines the damaged drywall portion, shape, size, wall thickness, and other parameters. These parameters may, for example, be used to select the TDSRA head size and patch. In step 140, the user applies the textures drywall surface tool at the center of the aperture to remove the existing surface and create a predetermined aperture. In step 142 a user determines whether the drywall texture portion is removed. The texture of the drywall may, for example, be scraped off. For example, some portions of the drywall may be removed to create cavities. A user may, for example, in step 135 determine the amount of drywall texture to be removed. A user may, for example, determine in step 135 the amount of drywall to be removed. If not, the user continues to remove the existing texture and drywall in step 142 to meet the determination made in step 135. The user may, for example, continue to remove the portion until the shoulder of the drywall is removed. If yes, the user may, for example, proceed to step 145. In step 145, a user prepares and applies the repair patch. In step 150, the user blends the coupling area between the patch and wall. In step 155, the user determines if the coupling area is blended. If yes, the repair was successful. If not, the user may, for example, continue to blend until the wall is repaired.

FIG. 4A-4B depict perspective views of an exemplary TDSRA embodiment 400. The TDSRA embodiment 400 includes a receiving tip 410. The receiving tip may, for example, receive a blade. The TDSRA embodiment 400 includes a blender 120b. The TDSRA includes a grip 405.

As the centering projection centers the blade relative to the damage/hole in the wall, and the blade removes existing texture within a predetermined radius around the hole the width of the blade may, for example, correspond to a diameter of the pre-textured wall patch.

Some embodiments may, for example, include a moving blending protrusion to a removable cap that goes over top of tool (blade & centering protrusion side). Some embodiments may, for example, include the removable cap at the base of tool opposite of the centering protrusion. Some embodiments may make the removable cap so that the blade is covered (for safety) and cap must be re-installed on tool afer using it to ream the surrounding texture around hole to use

Some embodiments, may, for example, include an entire centering tip/protrusion as conical. Some embodiments may, for example, include want for a predetermined front portion of the protrusion is a pyramidal shape (or other geometric shape with edges) so that as the tool is turned into the existing anchor hole.

Some embodiments may, for example, include a pyramidal portion of the protrusion confiugred to cut “cuts” into the hole, or bores into the hole, and then the base of the centering protrusion retains its conical geometry so that once the shoulder flange extending beyond the cutting blade makes contact with the wall surface, the tool will smoothly rotate in the hole. This embodiment may, for example, prevent boring.

Some embodiments may, for example, allow one sized centering protrusion to more easily be used on a variety of anchor hole sizes. Without adding a pyramidal or other geometric shape with edges to the end of the centering protrusion, it would take a considerable amount of effort and force for the user to work the purely conical tip into existing smaller anchor holes. The end of the conical centering protrusion could be coated with an abrasive.

Some embodiments may, for example, include carve outs that drop below the flange surrounding the cutting blade so that as the tool is turned to cut out existing wall texture surrounding the anchor hole, the cut off texture is “cleared” from the cutting blade to keep it from gunking up the cutting edge. The carve out could be an actual carve out, or could be formed in the tool so that it slopes away from the flange next to the cutting portion of the blade.

Some embodiments may, for example, include a flattend conical tip to prevent from being used on holes too small to effectively use the given sized tool's conical tip. Tips sized may, for example, be configured for the hole ranges where it would be most effective for the user

The carve out could be an actual carve out, or could be formed in the tool so that it slopes away from the flange next to the cutting portion of the blade.

Some embodiments may, for example, accommodate different wall hole sizes, the front portion of the projection was designed to be polygonal (such as a pyramid or other geometric shapes with edges) or polygonal bounded by a conical frenum. This polygonal shape allows the projection to more easily cut into the hole. As the tool is turned into the existing hole in the drywall, the polygonal portion transitions to a cylindrical geometry around the center axis of the projection. This transition ensures that as the cutting blade makes contact with the wall surface, the tool rotates smoothly within the hole, preventing the tool from boring further into the wall once the shoulder flange extends beyond the cutting blade and contacts the wall surface.

Some embodiments allow one-sized centering projections to be used with various anchor hole sizes. The polygonal or other geometric shape with edges to the end of the centering projection may, for example, be used for smaller anchor holes. By transitioning from a polygonal front geometry to a cylindrical geometry, the tool may, for example, rotate more smoothly within different hole sizes, creating more desirable cavities in the wall surface textures. This may, for example, facilitate the application of a pre-textured wall patch.

In some embodiments, the flange extending beyond the cutting blade may surround and extend radially around the base or back of the centering tip/projection. This feature may, for example, ensure that the tool is consistently rotated perpendicularly to the wall surface, avoiding any skewing of the axis of rotation. This results in more desirable cavities in the wall surface textures, ready to receive the pre-textured wall patch.

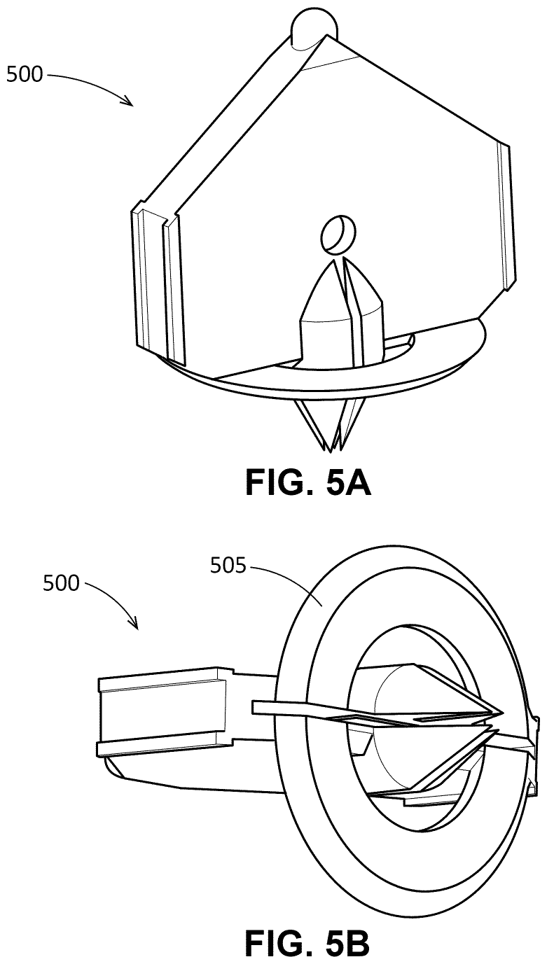

FIG. 5A-5B depicts views of an exemplary TDSRA embodiment 500. This embodiment includes a circular tab 505. The tab may, for example, steadily the user may be able to turn the exemplary TDSRA such that the user is able to spin the TDSRA in a singular plane parallel to the tab.

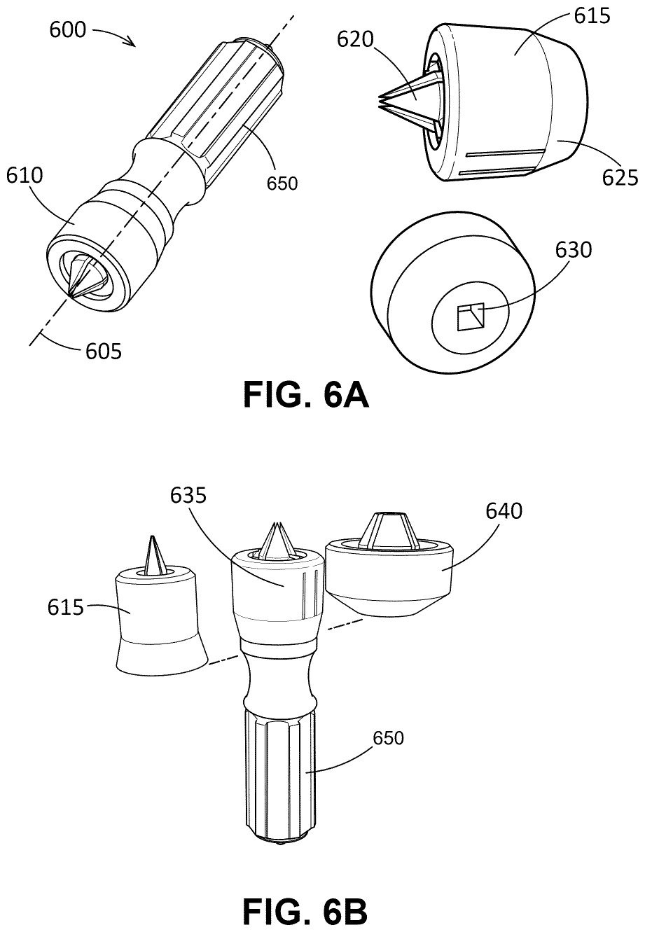

FIGS. 6A-6B depict views of an exemplary TDSRA embodiment set 600. The exemplary TDSRA 120 includes longitudinal axis 605 extending across the TDSRA handle embodiment including detachable heads. The centering head may, for example, be coupled to the handle. The exemplary TDSRA 120 includes a head 610. The exemplary TDSRA includes a head 610. The exemplary TDSRA may, for example, includes sets of heads to cover diameter holes between ⅛″ to 6″.

FIG. 6B depicts a narrow head portion 615. FIG. 6B depicts a standard head portion 635. FIG. 6B. depicts a large head portion 640. The heads include a coupling aperture 630 on the opposing side of a centering protection 620. The head may, for example, couple to the handle along the longitudinal axis 605. The head 610 includes a body 615. The head includes a taper 625. The taper may, for example, be used to disambiguate the handle form the centering protrusion head. The head 610 may, for example, be coupled to the handle 650 as depicted in FIG. 6A. A user may, for example, select from a set of centering protrusion heads (e.g., 615, 635, 640) to couple to the handle 650. (as depicted in FIG. 6B).

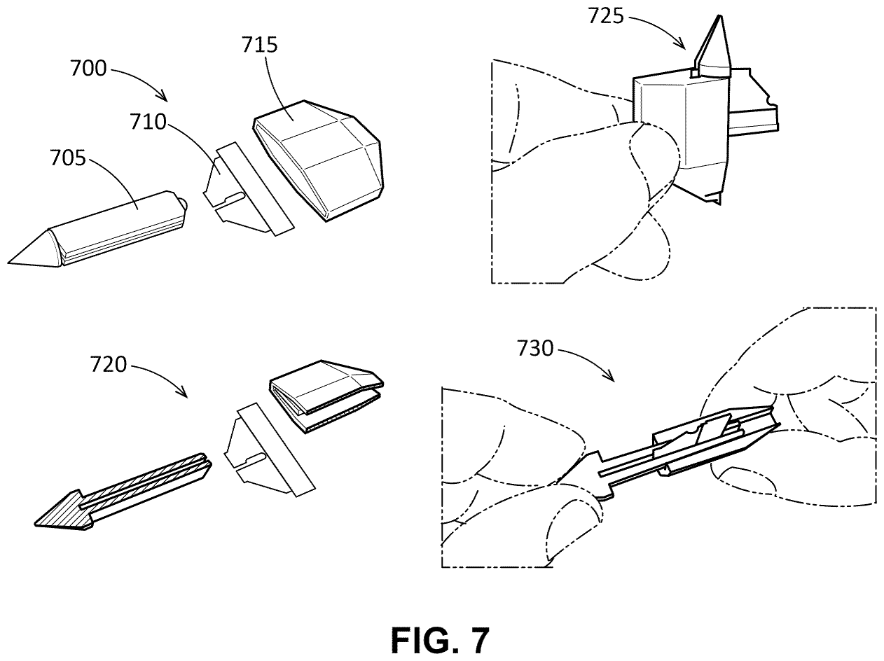

FIG. 7 depicts an exemplary assembly of an exemplary TDSRA embodiment 700. The exemplary TDSRA embodiment 700 includes a centering protrusion member 705. The exemplary TDSRA embodiment 700 includes a body 715. The exemplary TDSRA embodiment includes a split blade 710. In some embodiments, the split blade may, for example, unsplit. In step 720, a user provides a first section of the body to a split blade and centering protrusion member. In step 725, a user assembles the first section of the body to the split blade and centering protrusion member In step 730 the user assembles a second body portion including prongs to the first body portion.

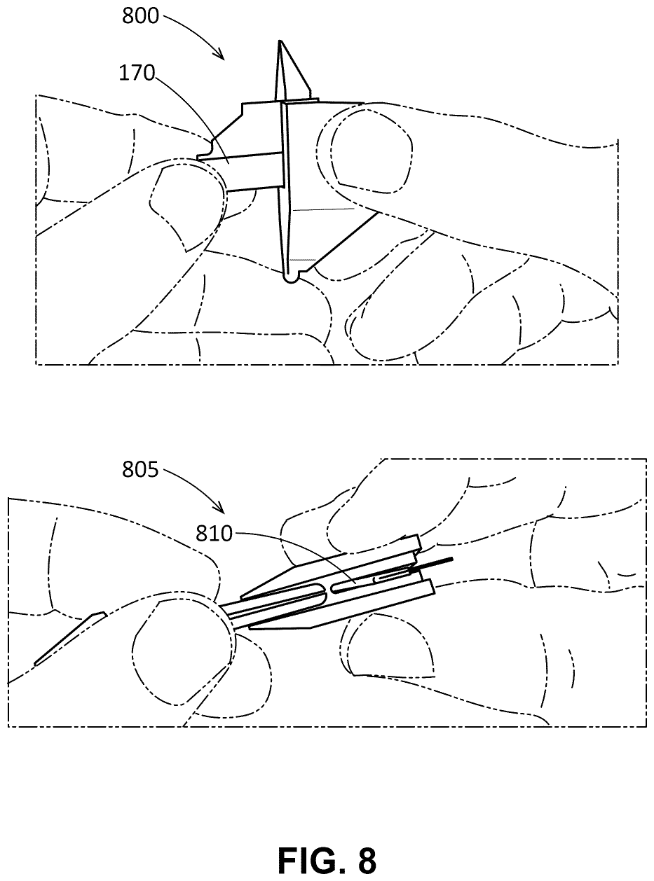

FIG. 8 depicts an exemplary disassembly of an exemplary TDSRA embodiment 800. The user may, for example, depress the blending protrusion into the body centering pin to loosen the centering pin from the body and grab the cone to remove the centering pin component and blade to change out the blade. In step 805, if the user experiences debris 810 the user may, for example, press the centering protrusion member to remove the debris and then remove the blade 170. The exemplary TDSRA embodiment 700 includes a centering protrusion member 705.

In some embodiments, the blade may be a single flat piece that travels through the centering projection. The base of the blade may be installed into to tool so that it is stationary. The blade may be cut in the center starting from the top towards the centering projection, but not completely through the base of the blade so that as the tool is rotated, each cutting edge of the split-blade is able to individually flex and deflect away from the direction of the tool's rotation relative to its mounting within the tool which is perpendicular to the face of the flange (parallel to the centering projection's axis).

In some embodiments, the blade embodiment may, for example, be used to make the tool function smoothly. Other blade configurations may be used (split-blade, solid blade, 2 separate blade sections, etc.). For a solid blade, the rotational forces on each end acting on the solid blade may, for example, cause stress on the middle. For slit blades, the rotational forces on each end may, for example, be segregated by the cut in the blade. Blade ends may, for example, flex and deflect separately.

In some embodiments, the TDSRA may, for example, include a “blade” on its front side, which faces the wall surface. This body may, for example, incorporate features such as patch storage, patch dispensing, ergonomic design, and various operation methods (including hand-operated, tool attachment, or electric).

Some embodiments of the TDSRA may, for example, include a centering projection, which helps to register the tool around a hole in the wall. This projection may, for example, be configured in several ways: centeringly within the body, shrouded around the body, or offset from the body by a radius arm. The projection may, for example, be fixed, rotating, or sliding within the body, and it can be removable and replaceable with different projections. Specifically, the centering projection may be fixed within the body, rotate within the body radially, or slide within the body axially. It may also be spring-loaded such that a conical or other tapered tip can face away from the cutting face towards the wall, allowing the tool to bore a static/fixed conical tip into a wall hole. Various projection shapes, geometries, and methods allow it to rotate centeringly around the hole or defect, creating a desirable cavity within the wall surface texture. Additionally, the centering projection may, for example, have gripping methods for centering within wall defects that are not through-holes, such as a dent in the wall.

Some embodiments of the TDSRA may, for example, include a flange designed to limit the depth of insertion of the blade into the wall to correspond to the thickness of the pre-textured wall patch. The blade itself may, for example, be used to remove existing texture within a specified radius around the hole and can have various configurations and attachments for different cutting, grinding, abrading, scraping, or other removing purposes. The blade can be attached to the body in several ways, including being molded into the body or attached with adhesives or mechanical fasteners. Blade shapes can vary, including fields of matrixed polygonal protrusions, linear blades, multiple lines of blades, or abrasive discs.

The blending projection may, for example, be applied at the junction between the edge of the pre-textured wall patch and the existing texture. This projection can be domed or have other desired shapes, and it may be affixed anywhere on the tool, a tool cap, or as a separate component in the kit.

Some embodiments of the TDSRA may, for example, be used in repairing through-holes, dents, nail pops, wallpaper defects, and other wall surface imperfections. The tool, method, patch, and kit are designed to address these additional types of damage, making the TDSRA a comprehensive solution for various wall repairs. This TDSRA may, for example, improve the repair process and ensure consistent results across different wall surface issues.

FIG. 9 depicts disposable single-use spackle dispenser/applicator for small repairs and patches in drywall. The disposable single use-spackle applicator may, for example, be referred to as the putty-pack. The disposable single-use spackle dispenser may, for example, be used as a stand-alone solution or as a complement to a previously described drywall patch kit. The putty-pack may, for example, be used for designed for small holes (e.g., 0.25″ diameter or smaller, such as picture hanging nails) where adding texture to a patch may not be necessary).

FIG. 9 depicts an exemplary plaster container 905. The plaster container 905 includes a first predetermined path 906. The plaster container includes a second predetermined path 907. The cross-sectional area associated with the cross-section may, for example, be different. The cross-section of the predetermined path 906 may, for example, be greater than the cross-sectional area associated with the predetermined path of 907. The plaster container 905 includes an opposing end 908 that may, for example, be ripped off to dispense a larger amount of plaster.

FIG. 9 depicts a tubular plaster container 910. The plaster container 910 includes individual units 912. The individual units may, for example, be releasably coupled to each other. The tubular plaster container 910 includes a first axis 911 in which a cap is disposed onto. The cap may, for example, be removed to allow a user to remove a large portion of putty at one time. The plaster containers 912 include a nozzle 913. The cap may, for example, be removed from the nozzle to dispense the putty at one time.

FIG. 9 depicts a plaster container chain 915. The plaster container chain 915 includes a first nozzle 916. The plaster container chain 915 includes at least one plaster container 917. The plaster container chain includes a second nozzle 919. The plaster container chain includes separation lines 918 where the containers may, for example, be separated. The plaster container includes a separate plaster container that may, for example, be broken form the plaster container chain 915.

The containers may, for example, contain materials that include gypsum. The materials include may, for example, include plaster. The container may, for example, include spackle. The containers may, for example, include putty-gypsum containing material.

FIG. 9 depicts a plaster container series 920. The plaster container series depicts a nozzle created from cutting the corner of the plaster container 921. The plaster container series 920 include different sized plaster containers in the series. The plaster container series 920 includes a medium sized plaster container 923. The plaster container series 920 includes a smaller container 922. The plaster container series 920 includes a second nozzle created from cutting an opposing corner 924. The plaster container series may, for example, have different cross sectional dispensing areas based on the path in which the corner is cut.

In some embodiments, the plaster container may, for example, include different forms, such as a sphere. These containers are designed for wall repair, such as repairing nail holes and other small holes in the wall. The plaster container may, for example, be small and includes a thin layer of plastic, making it easy to handle. These containers can be stored in a jar or on a string, emphasizing their modularity and convenience. The plaster container may include a twist-off feature for easy access to the plaster and a guiding valve for precise application.

In some embodiments, the putty-pack offers several advantages. It comes in single-use, small-volume containers (less than 10 mL, ideally under 3 mL), intended to be used entirely in one application and then discarded. This embodiment may, for example, avoid the issues associated with repeated openings of larger containers, which can reduce shelf life due to drying out. The putty-pack containers can be stored in various configurations, such as attached in a string or loose in a jar and may feature easy-tear plastic film or more rigid plastics like HDPE or LDPE. The containers can be opened by hand without tools, using tear notches, break-off tips, or foil seals, and they are designed for single-use to ensure the spackle remains ready-to-use for each repair.

The general shape of the putty-pack can vary, including cylindrical with conical ends or rectangular, and can be made from flexible or rigid materials. The spackle may, for example, come in multiple dry color options to match different wall colors, potentially eliminating the need for painting after repair.

FIG. 10 depicts an exemplary method 1000 of utilizing the TDSRA to repair damaged drywall. The method includes a user using a plaster container containing spackle 1005. The user has determined the hole 1010. The hole 1010 corresponds to a predetermined fastener 1015 embedded into the drywall. The user selects the plaster container based on the sized the hole and the size of the fastener that was embedded in the drill wall. The holes may, for example, be associated with fastener previously embedded in the drywall that may, for example, include nails, screws, and/or bolts.

The user in step 1020 removes the cap along a predetermined path. The path may, for example, be perforated. The plaster container 1025 has an aperture corresponding to the path chosen. In step 1030, the plaster is dispensed from the container int other wall. In step 1035, the user taps the plaster to create a flat surface. The user may, for example, use their finger 1040. Step 1045 depicts a flat surface that was repaired with the use of the plaster container.

The user may, for example, hold and position the plaster container near the wall holes, preparing to dispense the plaster. The user may, for example, then twists or opens the nozzle of the container, beginning the application of plaster into the holes. As the user continues to dispense the plaster, the user may, for example, carefully fill each hole, ensuring the guiding valve directs the plaster exactly where needed. The valve may, for example, minimize waste and ensures an even application. The user fills the holes completely, applying enough plaster to cover and fill the defects. Following the application, the user may, for example, smooths the plaster using a tool or finger, making the surface even with the surrounding wall.

FIG. 11 depicts an exemplary series of wall patches 125. The wall patches include a smooth texture 1105. The wall patches include a bumpy texture 1110. The wall patches include a textured smooth texture 1115. A user may, for example, after making a repair determine which patch to use. The user may, for example, select a patch that corresponds to their preexisting drywall.

Some TDSRA embodiments may, for example, create a cavity around a hole in a wall by removing the existing texture to fit a pre-textured wall patch. Patches used with this tool may, for example, have varied textures such as orange peel, knockdown, smooth, and others, and may also be used to repair patches of wallpaper or other wall coverings. Hole may, for example, refer to dents or surface defects in the wall. Hole may, for example, refere to-holes in drywall. Texture may, for example, refer to wall coverings like wallpaper or the top layer of the wall surface.

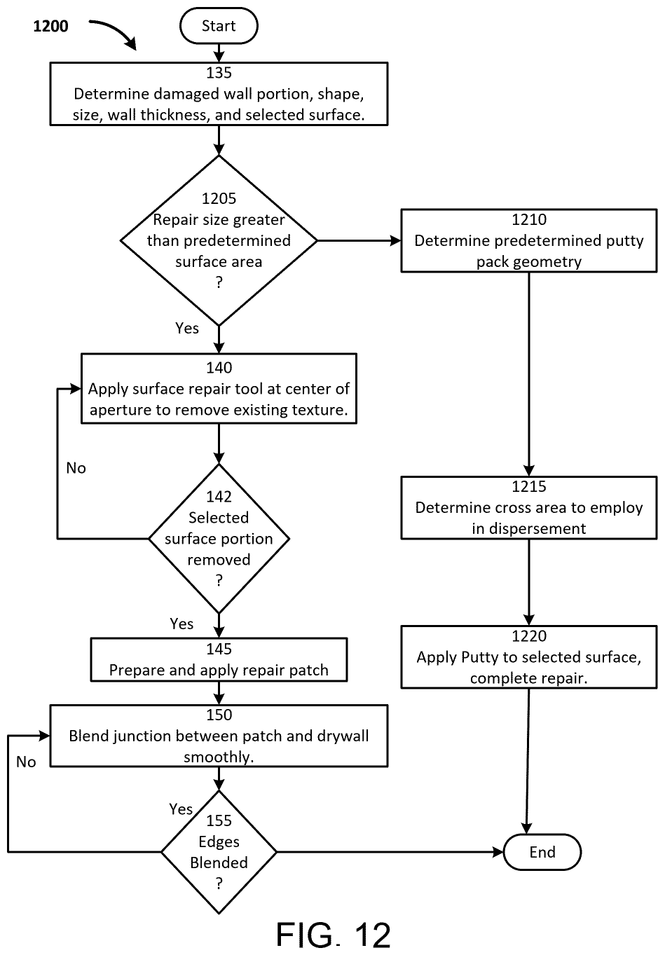

FIG. 12 depicts an exemplary method of using a putty pack and TDSRA combination kit for wall repair 1200.

In step 135, a user determines the damaged wall portion's shape, size, wall thickness, and etc. The damaged drywall may, for example, include an irregular shaped aperture. The TDSRA 120 includes a centering protrusion. The exemplary TDSRA includes an exemplary surface removing member. The surface removing member may, for example, include a blade. The surface removing member may, for example, be proximally disposed to a distal end of the centering protrusion member. The surface removing member extends past a surface interface plane member. The surface interface plane member may, for example, be disposed proximally to a distal end of the surface removing member.

In decision point 1205, the user determines whether the repair size is greater than the predetermined surface area. If the user determines the repair size is greater than the predetermined surface and may a patch repair proceed to step 140. If the user determines the repair size is less than the predetermined surface then the user may, for example, proceed to step 1210. The predetermined area may, for example, be less than a square inch. The predetermined area may, for example, be a quarter of an inch squared. The predetermined area may, for example, be an eighth of an inch squared.

In step 1210, the user may, for example, determine the predetermined putty pack geometry. The user may, for example, choose from the geometries laid out in FIG. 9. The user may, for example, choose a tubular putty plaster container. The user may, for example, choose the plaster container based on the type of repair may.

In step 1215, the user may, for example, determine the cross area to deploy in the spackle disbursement. The tubular putty plaster container may, for example, include opposing sides with different cross-sectional areas. One cross section area may, for example, be larger than the other. The cross-sectional area may, for example, be ½ in squared, and ¼″ squared on the opposing side.

In step 1220, the user may, for example, apply the plaster to the selected surface to complete the repair.

In the alternative, if the user decides the putty pack repair is unsatisfactory, the user may, for example, proceed to step 140. The user may, for example, proceed to step 140 directly if the user determined the repair size was greater than a predetermined area.

In step 140, a user may, for example, center the TDSRA onto the irregular shaped aperture. The user may, for example, turn the TDSRA counterclockwise, counterclockwise, or alternating directions along the longitudinal axis of the device in motion A such that cone shape and blade create a predetermined shape cavity. The surface removing member may, for example, be configured to create a predetermined shape cavity with a predetermined cross-sectional area when rotated about its longitudinal axis. The blade scrapes away the drywall texture as the TDSRA is turned around the cone. The regular shape may, for example, include a circle.

The cone and blade may, for example, create the properly sized cavity to accept the patch. The blade may, for example, carve the cavity. The texture of the drywall may, for example, be scraped off. Portions of the drywall may, for example, be removed to create the cavity.

In step 145, the user removes a patch and is removed from a predetermined wall patch sheet 125a. The predetermined wall patch is then applied to the damaged drywall with a predetermined shape cavity. The predetermined patch may, for example, include a series of predetermined textures to match different types and textures of drywall.

In step 150, the user prepares and applies the drywall patch. to the damaged drywall. In step 150, the user applies a blender portion of the TDSR to the drywall (as depicted in motion C in FIG. 1). The blender is used to blend the gap 115c between the patch and the damaged drywall.

In step 155, the user reinspects the wall. If the wall is blended the user has successfully repaired the wall. If the wall may more blending, the user will continue step 150 until the blending between the wall and patch is successful.

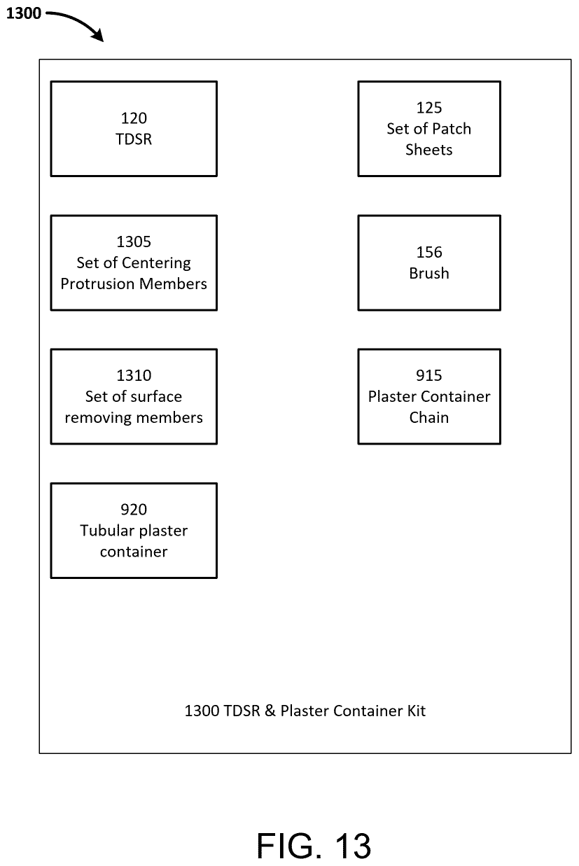

FIG. 13 depicts an exemplary combination kit 1300 including a TDSRA and a set of putty packs. The exemplary combination kit 1300 includes an exemplary TDSR 120. In some kit embodiments, different sets of TDSRs may, for example, be provided. The TDSR may, for example, include TDSR embodiment including a handle. The kit in some embodiments may, for example, include different handles and/or heads.

The exemplary combination kit 1300 includes a set of centering protrusion members 1305. The centering protrusions members may, for example, be interchanged based on the needs of a user. The exemplary combination kit 1300 includes a set of surface removing members. The set of surface removing members may, for example, include a set of blades. The set of surface removing may, for example, include an abrasive.

The exemplary combination kit 1300 includes an exemplary set of surface removing members 1310. The surface removing members may, for example, include blades. The blades may, for example, be split. The blades may, for example, be whole. The surface removing members may, for example, include an abrasive blade. The surface removing member may, for example, include a hard plastic.

The exemplary combination kit 1300 may, for example, include a set of patch sheets 125 (for example as depicted in FIG. 11). The patch sheets may, for example, be used in connection with the TDSR in repairing drywall. The exemplary combination kit 1300 may, for example, include a brush 156. The brush may, for example, be used to assist with the plaster container, TDSR, patch sheets, and plaster containers.

The exemplary combination kit 1300 may, for example, include a plaster container chain 915 and plaster container 920. (as depicted in FIG. 9). The exemplary combination kit 1300 may, for example, include a tubular plaster container 910. (as depicted in FIG. 9). The exemplary combination kit 1300 may, for example, include plaster containers 905. (as depicted in FIG. 9).

Although an exemplary system has been described with reference to FIGS. 1-13, other implementations may be deployed in other industrial, scientific, medical, commercial, and/or residential applications. The TDSRA may, for example, be sold in a kit. The kit may, for example, include an exemplary TDSRA. The kit may, for example, include blades. The kit may, for example, include handles. The kit may, for example, include drywall patches.

In industrial settings, the Textured Drywall Surface Repair Apparatus (TDSRA) may, for example, be used to maintain the integrity of textured walls in factories and warehouses. The tool's precision in creating cavities for pre-textured patches ensures quick and efficient repairs, minimizing downtime and maintaining safety standards. Its ability to handle various textures like orange peel and knockdown makes it versatile for different wall types commonly found in industrial environments. The TDSRA may, for example, help in preventing further damage by providing a seamless blend, which is important in high-traffic areas where wall integrity is constantly tested.

Putty packs, as disclosed, may, for example, be used in industrial environments for quick, small-scale repairs. Their single-use design eliminates the risk of spackle drying out, ensuring fresh and ready-to-use material every time. The small size of the putty packs makes them ideal for addressing minor damages like nail holes or small dents without interrupting operations. Moreover, the ease of use and no requirement for additional tools make them a convenient solution for maintenance teams.

In scientific environments, the TDSRA may, for example, be used in maintaining laboratory walls. Laboratories may, for example, require precise conditions, and the TDSRA may, for example, ensure that any damage to textured walls is repaired quickly and accurately, preserving the integrity of the experimental environment. The tool's ability to blend repairs seamlessly into existing textures helps maintain a consistent and controlled setting.

Putty packs may, for example, be highly beneficial in scientific settings for minor wall repairs. Their single-use nature is particularly advantageous in labs, where maintaining a contaminant-free environment is important. The ease of application and the precise control provided by the putty packs ensure that minor damages can be repaired without the risk of introducing contaminants.

In medical facilities, the TDSRA may, for example, ensure that wall repairs are carried out swiftly and hygienically. Putty packs may, for example, be particularly useful in medical settings due to their disposable nature, which ensures hygiene. The putty packs' design eliminates the need for additional tools, reducing the risk of contamination and making them a safe choice for use in sterile areas. The availability of different colors also helps match the repairs to the existing wall colors, maintaining the aesthetic consistency of medical facilities.

In commercial properties, the TDSRA may, for example, be used for maintaining the aesthetic and functional integrity of office buildings, retail spaces, and other commercial environments. The tool's ability to quickly repair and blend textured wall damages ensures minimal disruption to business operations.

Putty packs may, for example, offer a convenient solution for small-scale wall repairs in commercial settings. Their single-use design ensures that repairs are quick and clean, minimizing downtime and disruption.

In residential settings, the TDSRA provides homeowners with an efficient tool for repairing textured wall damages. The TDSRA may, for example, be used for small dents and/or a larger hole. The TDSRA may, for example, ensure that repairs are quick and blend seamlessly with the existing wall texture. Putty packs may, for example, be used in residential applications, to offer an effective way to repair small wall damage like nail holes and dents. Their single-use design may, for example, ensure that homeowners have fresh spackle ready for use, eliminating the frustration of dried-out material. Putty packs may, for example, include different colors of spackle/plaster allowing homeowners to match repairs with existing wall colors, maintaining the aesthetic consistency of their interiors.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. A textured drywall surface repair apparatus comprising:
a centering protrusion member extending along a longitudinal axis;
a body extending along the longitudinal axis;
a surface removing member proximally disposed to a distal end of the centering protrusion member configured to create a cavity with a predetermined cross-sectional area when rotated about the longitudinal axis; and,
a surface interface plane member disposed proximally to a distal end of the surface removing member and at least partially radially outward from the surface removing member such that the cavity is limited to a predetermined depth.

2. The textured drywall surface repair apparatus of claim 1, wherein the predetermined depth is less than a thickness of a material in which the cavity is made.

3. The textured drywall surface repair apparatus of claim 1, wherein the centering protrusion is conical.

4. The textured drywall surface repair apparatus of claim 1, wherein a distance d1 between the distal end of the centering protrusion member and the surface removing member is greater than a distance d2 between the distal end of the centering protrusion member and the surface interface plane member.

5. The textured drywall surface repair apparatus of claim 1, wherein the surface removing member comprises an abrasive material.

6. The textured drywall surface repair apparatus of claim 1, wherein the surface interface plane member comprises a circular tab revolving around the longitudinal axis of the centering protrusion member.

7. The textured drywall surface repair apparatus of claim 1, wherein the centering protrusion member is affixed to the surface interface plane member.

8. The textured drywall surface repair apparatus of claim 1, wherein the centering protrusion member is slidably insertable into a centering aperture surface interface plane member and through the body.

9. The textured drywall surface repair apparatus of claim 1, wherein the body further comprises a blending member on an opposing side of the centering protrusion member extending along the longitudinal axis.

10. The textured drywall surface repair apparatus of claim 1, wherein the body further comprises:
a surface removing member cavity configured such the surface removing member is inserted into the cavity and the surface removing member extends past the surface interface plane member when inserted; and
a centering protrusion member cavity intersecting the surface removing cavity extending along the longitudinal axis.

11. The textured drywall surface repair apparatus of claim 10, wherein the body further comprises:
a first body segment comprising a bisected body with a set of opposing prongs configured to be received by a second bisected body segment with a receiving aperture configured such that the prongs of the first segment may be squeezed together to be inserted into the second body segment coupling the first body segment to the second body segment;
wherein the surface removing member is inserted between the prongs before coupling the first body segment and the second body segment such that the surface removing member is coupled to the body as formed.

12. The textured drywall surface repair apparatus of claim 10, the body further comprises:
an engagement aperture configured such that when the removing member is inserted into the body, the removing member is secured to the body by a fastener to the body.

13. The textured drywall surface repair apparatus of claim 10, further comprising:
a handle with a distal engagement member extending along the longitudinal axis that is configured to couple to a rear of the body, wherein the body comprises a receiving member configured to couple the body to the handle.

14. A surface repair kit comprising:
a textured drywall surface repair apparatus comprising:
a centering protrusion member extending along a longitudinal axis;
a body extending along the longitudinal axis;
a surface removing member proximally disposed to a distal end of the centering protrusion member configured to create a cavity with a predetermined cross-sectional area when rotated about the longitudinal axis; and,
a surface interface plane member disposed proximally to a distal end of the surface removing member and at least partially radially outward from the surface removing member such that the cavity is limited to a predetermined depth; and,
at least one surface repair patch comprising:
at least one wall patch comprising at least one side having a predetermined drywall texture.

15. The surface repair kit of claim 14, wherein the at least one wall patch is selected from a wall patch sheet.

16. The surface repair kit of claim 14, further comprising: a brush; and a container containing a predetermined amount of plaster.

17. The surface repair kit of claim 14, further comprises:
a set of blades;
a set of centering protrusion members;
a set of fasteners configured to couple the surface removing member to the body; and,
a fastener engagement tool configured to fasten the fastener to the body.

18. The surface repair kit of claim 14, further comprising disposable releasably coupled modular single use plaster containers comprising:
at least one container containing predetermined amount of plaster fluid;
at least one nozzle with a predetermined cross area at an end of the container; and
a cap coupled to the end of the nozzle configured such that the cap may be decoupled from the nozzle to dispense the predetermined cross area of plaster fluid when the container is squeezed.

19. The surface repair kit of claim 18, wherein the disposable releasably coupled modular single use plaster containers further comprise:
at least two containers coupled together along predetermined paths, that may be decoupled by tearing along the predetermined paths.

20. The surface repair kit of claim 18, wherein the disposable releasably coupled modular single use plaster containers further comprise two opposing nozzles with different cross-sectional areas configured such that a corresponding cap may be removed to dispense the plaster to the corresponding nozzle with the corresponding cross-sectional area.
